(19) United States
(12) Patent Application Publication
(10) Pub. No.: US 2024/0274831 A1
(43) Pub. Date: Aug. 15, 2024

(54) ONIUM SALT DERIVED MATERIALS AS CHALCOGEN HOSTS

(71) Applicant: DREXEL UNIVERSITY, Philadelphia, PA (US)

(72) Inventors: Rahul Nagesh PAI, Philadelphia, PA (US); Vibha KALRA, Garnet Valley, PA (US); Michel W. BARSOUM, Moorestown, NJ (US); Hussein O. BADR, Philadelphia, PA (US)

(21) Appl. No.: 18/568,358

(22) PCT Filed: Jun. 10, 2022
(86) PCT No.: PCT/US2022/072881

§ 371 Date: Dec. 8, 2023

Related U.S. Application Data
(60) Provisional application No. 63/209,318, filed on Jun. 10, 2021.
(60) Provisional application No. 63/210,238, filed on Jun. 14, 2021.

(51) Int. Cl. H01M 4/62; H01M 4/02; H01M 4/13; H01M 10/052

(52) U.S. Cl. CPC H01M 4/628; H01M 4/13; H01M 4/623; H01M 10/052; H01M 2004/028

(57) ABSTRACT

By combining two-dimensional (2D) transition metal oxide and/or carbo-oxides with sulfur, one can form cathodes for use in Li—S batteries, which batteries in turn exhibit high capacity and other attractive characteristics. Accordingly, provided herein are methods, comprising: forming an admixture that comprises sulfur, a 2D transition metal carbo-oxide, and optionally a conductive material. Also provided are electrodes, comprising sulfur, a 2D transition metal carbo-oxide, and optionally a conductive material. Further provided are energy cells, the energy cell comprising a first electrode according to the present disclosure. Additionally provided are methods, the methods comprising discharging an energy cell according to the present disclosure or charging an energy cell according to the present disclosure. Also provided are electrical devices, comprising an energy cell according to the present disclosure.

### CROSS-REFERENCE TO RELATED APPLICATIONS

The present application claims priority to and the benefit of U.S. patent application No. 63/209,318, “Two-Dimensional Titanium CarboOxide Polysulfide Immobilizers” (filed Jun. 10, 2021), and U.S. patent application No. 63/210,238, “Onium Salt Derived Materials As Chalcogen Hosts” (filed Jun. 14, 2021), the entireties of which foregoing applications are incorporated herein by reference for any and all purposes.

### GOVERNMENT RIGHTS

This invention was made with government support under grant no. 1919177 awarded by the National Science Foundation. The government has certain rights in the invention.

### TECHNICAL FIELD

The present disclosure relates to the field of materials useful in rechargeable batteries, in particular to the field of cathode materials.

### BACKGROUND

Over the past few decades there has been a steady increase in demand for efficient energy storage devices due to the ever-rising concerns about limited fossil energy supply and detrimental environmental effects. Due to high gravimetric energy density, rechargeable lithium-ion batteries have become the dominant in commercial market. Li-ion chemistry, however, has reached its theoretical limit and there is a critical need for next generation chemistries.

Sulfur is a promising cathode material for next-generation rechargeable system with a theoretical specific capacity of 1675 mAh·g⁻¹, which is ˜5 times higher than present day cathode materials of Li-ion batteries based on layered metal oxides. Nevertheless, there is a tremendous amount of hindrance for practical lithium-sulfur (Li—S) cathodes (as one example of metal-chalcogen combinations) due to inherent issues such as low electrical conductivity of sulfur and other chalcogens, dissolution of polysulfides in electrolyte, and volume expansion of sulfur during discharge. These problems further reduce cycle life and result into low specific capacity.

Accordingly, there is a long-felt need in the art for cathode materials that can support the use of sulfur (or other chalcogens) in rechargeable batteries.

### SUMMARY

In meeting the described needs, the present disclosure provides, inter alia, compositions, comprising a chalcogen, a composition comprising a 1 Da (i.e., a 1-dimensional anatase material), and optionally a conductive material. The 1 Da can be termed a quat-derived nanomaterial (QDN).

A 1 Da can be an oxide-based nanofilament and/or subnanofilament, and can optionally comprise an amount of carbon. (As described herein, the nanofilaments can comprise, e.g., titanium.) The composition can be present as a mesoporous powder in which the powder particulates comprise the oxide-based nanofilaments and/or subnanofilaments. The 1 Da composition can be present in the form of flakes, e.g., 2D bodies formed (e.g., via self-assembly) of 1 Da filaments. The 1 Da composition can also be present as 3D bodies, e.g, nanoparticles.

A 1 Da can exhibit a XRD pattern that, when compared to a XRD pattern of nano- or bulk anatase, exhibit reduced (104) and (105) peaks at around 380 and about 550 two theta (2θ). 1 Da nanofilaments and/or subnanofilaments can, in some embodiments, exhibit a Raman spectrum that is quite similar to that of bulk anatase, but can differ from bulk anatase in terms of the XRD spectrum, as described herein.

An 1 Da can be obtained by reacting starting materials (e.g., MAX-phase materials, carbides, nitrides, borides, sulphides, metals, and the like) with an onium salt (such as ammonium salts, TMAOH, TBAOH, TPAOH), e.g., at a temperature of from room temperature to 100° C. under ambient pressure. The admixture can optionally include an ammonium salt. An 1 Da can, as mentioned, be present as a 2D material, but this is not a requirement, as the 1 Da can also be present as a nanoparticle, a nanoribbon, nanowhiskers, nanotubes, a 1D material (e.g., fibers), or in other form.

Also provided are electrodes, comprising a composition according to the present disclosure (e.g., any one of Aspects 1-4), and the electrode optionally being configured as a cathode.

Further provided are energy cells, the energy cell comprising a first electrode according to the present disclosure (e.g., according any one of Aspects 5-7).

Also disclosed are methods, the methods comprising discharging an energy cell according to the present disclosure (e.g., any one of Aspects 8-13) or charging an energy cell according to the present disclosure (e.g., according to any one of Aspects 8-13).

Further provided are electrical devices, comprising an energy cell according to the present disclosure (e.g., any one of Aspects 8-13).

Also provided are methods, comprising: forming an admixture that comprises a chalcogen, a 1 Da, and optionally a conductive material.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1: Electrochemical characterization of TiC-based filtered films electrodes in Li—S cell: (a) cyclic voltammetry (CV) curves, (b) Charge-discharge curves of two-dimensional titanium carbo-oxide (1 Da) cathode at various current rates in Li—S cell. (c) Cycling stability at 0.2 C. S-loading is 0.8 mg. Capacity was, more or less, constant at ≈1000 mAh/g for about 300 cycles before fading.

FIG. 2 provides electrochemical cycling of two TiC derived 1 Da sulfur composites, making up 70% of the cathode, with an areal loading of 1 mg-cm⁻².

FIG. 3 provides illustrative cyclic voltammetry of a TiC 1 Da formed at 50 deg. C. for 5 days with 0.7 mg sulfur at various cycle rates.

FIG. 4 provides an illustrative rate study of a TiC 1 Da formed at 50 deg. C. for 5 days with 0.7 mg sulfur, showing a good rate capability at 1 C.

FIG. 5 provides the capacity contributions of 1 Da (TiC) materials formed at 50 deg C. for 5 days, showing the low capacity contribution of the 1 Da TiC in the voltage window of 1.8V to 2.6V, the voltage window of lithium sulfur. The specific capacity of the TiC 1 Da was 5 mAh/g and drops to 1.4 mAh/g in the second cycle.

FIG. 6 provides visual polysulfide test to observe interactions with TiC QDNs. Compared to carbon black, the 1 Das remove more polysulfides as seen in the picture after 7 days. Two concentrations were made, 0.5 mM and 2 mM.

FIG. 7 provides postmortem XPS of cycled cathodes with TiC 1 Da and sulfur. Showing the emergence of the polythionate peak in the S2p spectrum, elucidating the electrocatalytic mechanism of the polysulfide absorbance of TiC 1 Da. Without being bound to any particular theory, the occurrence of the lithium sulfur peak in both the S2p and the Ti2p spectrum demonstrates a Lewis acid base bonding mechanism.

FIG. 8 compares a pristine TiC 1 Da and a postmortem TiC 1 Da, showing shifts in the Ti—O peaks (dark blue and peach). Without being bound to any particular theory, this further suggest the interaction between polysulfides and the titanium in TiC 1 Das, as changes in the titanium coordination number can produce such shifts in binding energies.

FIG. 9 provides illustrative SEM of TiC 1 Das at various sonication treatments and reaction temperatures. The TiC 1 Da formed for 3 days at 80 deg. C. shows a more fibrous like surface than the TiC 1 Da formed for 5 days at 50 deg. C.

FIG. 10 provides an illustrative SEM of a cathode according to the present disclosure.

FIG. 11 provides an illustrative SEM of a post-mortem cathode top (left) and bottom (right).

FIG. 12 provides a SEM of a post-mortem cathode (in cross-section).

FIG. 13 provides illustrative performance for TiB 1 Da (formed at 80 deg C. for 3 days) Li—S cells, with a loading of 1 mg sulfur.

FIG. 14 provides SEM of a 1 Das TiB, made at 80 deg. C. for 3 days.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

Two-dimensional (2D) materials are gaining exponential attention for broad spectrum of energy storage applications because of their unique physical and chemical properties. 2D material have shown features such as high porosity, increased specific surface areas, good crystallinity, high conductivity and abundant tunable surface-active sites. The aforementioned properties make 2D materials an appropriate host for energy storage systems. Furthermore, 2D materials offer advantages that their 3D counterparts do not. Also, literature suggests the only way to fabricate 2D materials is via etching layered solids.

Provided herein is, inter alia, a novel way to mass produce 1 Da materials through a bottom-up approach and an approach for Li—S and other batteries, e.g., batteries that comprise a chalcogen. For the first time, such materials have been synthesized via use of non-layered precursors at near room temperature with improved properties, especially, conductivity and tunable functional groups. These unique properties of these materials are remarkable for Li—S system, in particular:
The insulating nature of sulfur combined with conductive 1 Da improves overall utilization of sulfur cathode;
Abundant functional groups on its surface namely hydroxyl and oxygen groups coupled with tunable oxidation state of Ti (or any other transition metal) and defects can provide affinity to bind lithium polysulfides, inhibiting the shuttle effect. Furthermore, the functional groups can form complexes, namely, thiosulfate and polythionate, with lithium polysulfides improving binding capabilities;
Free-standing flexible films of the disclosed 1 Da materials mixed with sulfur can provide good flexibility along with buffering the volume changes during cycling;
The conductive sheet surface with tunable functional groups can also impart catalytic properties further boosting conversion kinetics.

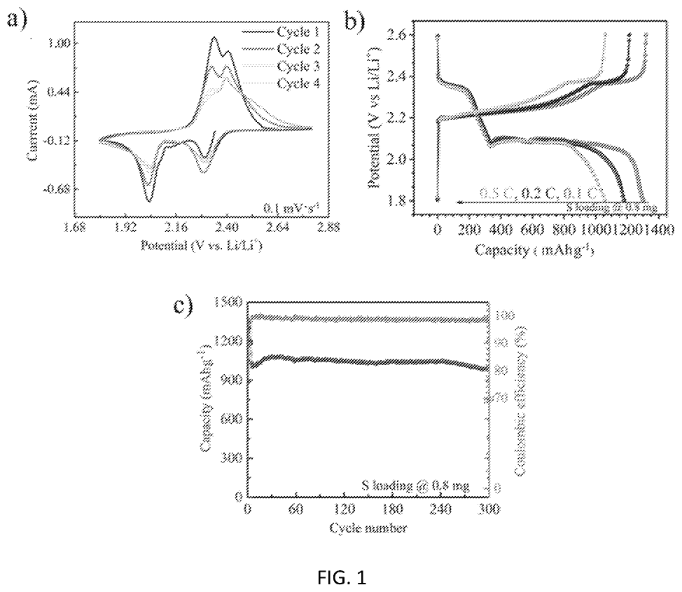

To explore the effect of 1 Da's in extending cycle life of lithium-sulfur system, we tested its behavior in coin cell configuration. FIG. 1A provides typical cyclic voltammetry (CV) curves in the 1.8-2.6 V (vs. Li/Li⁺) range at a scan rate of 0.1 mV·s⁻¹. The CV curves show two sharp and distinct cathodic and one anodic peak. The first cathodic peak at 2.3 V is ascribed to S reduction (Ss) to long-chain lithium polysulfides (LiPs), while the second peak is related to a subsequent reduction of LiPs to Li₂S₂/Li₂S. The peak shifts after the first anodic peak are possibly due to nucleation/reorganization during the redeposition of the LiPs back to Ss. FIG. 1B displays typical discharge plateaus consistent with the CV results. The TiCO/S composite electrodes deliver capacities of 1300, 1200, 1050 mAh g⁻¹ at 0.1, 0.2 and 0.5 C rates, respectively. Such high capacity can be associated with the TiCO conductivity, coupled with possible surface-active sites that bind to the LiPs. To evaluate the long-term stability, of the cathodes they were cycled at 0.5 C at a S loading of 0.83 mg cm⁻². FIG. 1C shows the cell delivers an initial capacity of ˜1300 mAh g⁻¹, which stabilizes to ˜1000 mAh g⁻¹ after the first 5 cycles. This initial drop is associated with the two conditioning cycles at low rate of 0.1 and 0.2 C. The composite delivers a capacity of ˜1000 mAh g⁻¹ after ˜300 cycles with around 100% retention. The capacity drops after 300 cycles. These values are excellent given that the cathode was crudely produced by a slurry blend—using a mortar and pestle—of the 1 Da flakes and commercially-purchased S powders.

### Experimental

To evaluate the performance of 1 Das as sulfur host in Li—S batteries, we prepared 1 Da/S cathodes using a slurry-based method. Briefly, the slurry was prepared by mixing 35 wt. % vacuum-dried 1 Das, 35 wt % sulphur, S, with 20 wt % conductive carbon (Alfa Aesar, Super P) and 10 wt. % battery grade PVDF binder (MTI Corp., USA). The materials were hand-ground with a mortar and pestle until the mixture appeared uniform. Later, N-Methyl-2-pyrrolidone (TCI, USA) was slowly added until the required visible consistency and uniformity of the slurry were achieved (˜25 minutes). The slurry was later cast on aluminum foil using a doctor blade (MTI Corp., USA) with a thickness of 20 μm. Once cast, the slurry was kept under a closed fume hood for 2 h before transferring to a vacuum oven where it was dried at 50° C. for 12 h.

The dried 1 Da/S cathodes were cut using a hole punch (diameter 11 mm) to form disks. The electrodes were then weighed and transferred to an Ar-filled glove box (MBraun Lab star, O₂<1 ppm, and H₂O<1 ppm). The CR2032 (MTI Corporation and Xiamen TMAX Battery Equipment) coin-type Li—S cells were assembled using 1 Da/S cathodes, a 15.6 mm diameter, 450 μm thick Li disk anode (Xiamen TMAX Battery Equipment) a tri-layer separator (Celgard 2325), and a stainless steel spring and two spacers along with the electrolyte. The electrolyte, with 1 M LiTFSi with 1 wt % LiNO₃ in a mixture of 1,2-dimethoxyethane and 1,3-dioxolane at a 1:1 volume ratio, was purchased from TMAX Battery Equipment, China and had trace amounts of oxygen and moisture (H₂O<6 ppm and O₂<1 ppm). The assembled coin cells were rested at their open-circuit potential for 10 h before performing the electrochemical experiments at room temperature. Cyclic voltammetry was performed at a scan rate of 0.1 mV·s⁻¹ between voltages 1.8 and 2.6 V wrt Li/Li⁺ using a potentiostat (Biologic VMP3). Prolonged cyclic stability tests were carried out with a battery cycler (Neware BTS 4000) at different C-rates (where 1 C=1675 mAh·g⁻¹) between voltages of 1.8 and 2.6 V. The Li—S cells were conditioned during the first cycle at 0.1 C, during the second cycle at 0.2 C, and at 0.5 C subsequently.

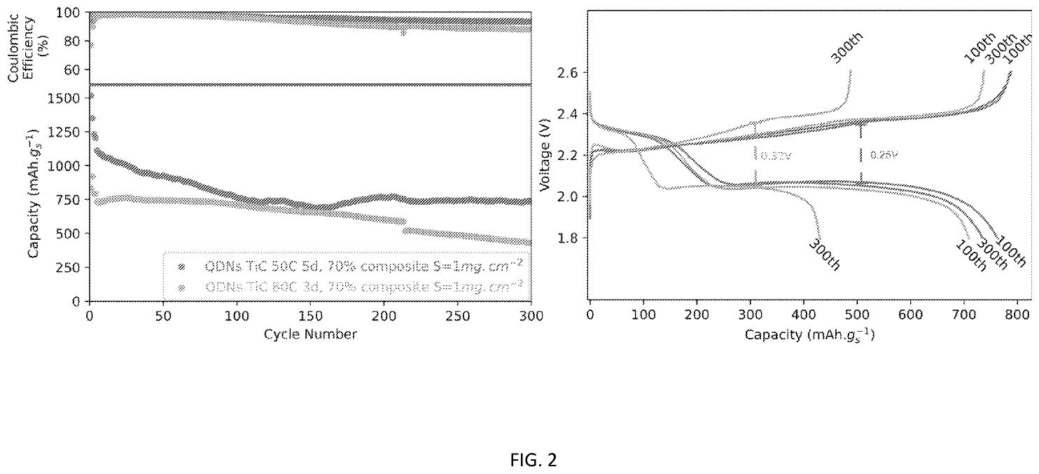

FIG. 2 provides electrochemical cycling of two TiC derived 1 Das sulfur composites, making up 70% of the cathode, with an areal loading of 1 mg·cm\hat{ }⁻². As shown, the TiC/S composite made at 50 deg. C. for 5 days retained its capacity at higher cycle numbers more than the TiC/S composite made at 80 deg. C. for 3 days. This is shown in both the left and right panels of FIG. 2.

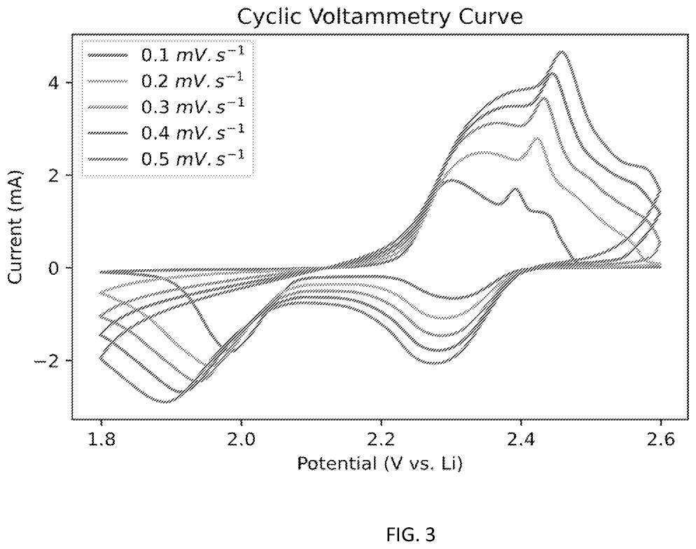

FIG. 3 provides illustrative cyclic voltammetry of 50 C 5d 1 Das with 0.7 mg of sulfur at various cycle rates.

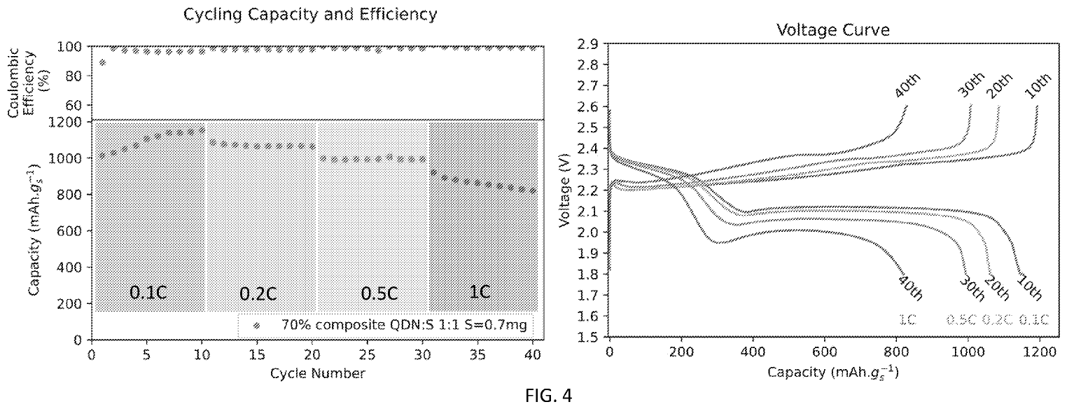

FIG. 4 provides an illustrative rate study of 50 C 5d TiC derived 1 Das 0.7 mg. As shown, the disclosed materials demonstrated a good rate capability at 1 C relative to 0.1 C, 0.2 C, and 0.5 C, demonstrating the disclosed materials' performance.

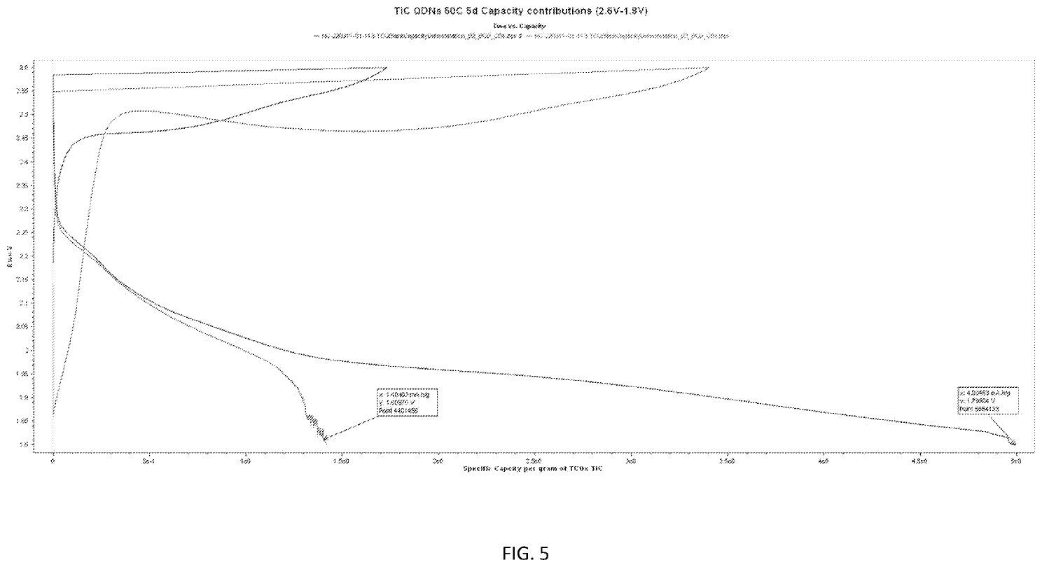

FIG. 5 provides capacity contributions of a 1 Da TiC material manufactured at 50 deg. C. for 5 days. As shown, the 1 Da TiC exhibits a low-capacity contribution in the voltage window of 1.8V to 2.6V, the voltage window of lithium sulfur. The specific capacity of TiC 1 Da is 5 mAh/g and drops to 1.4 mAh/g in the second cycle.

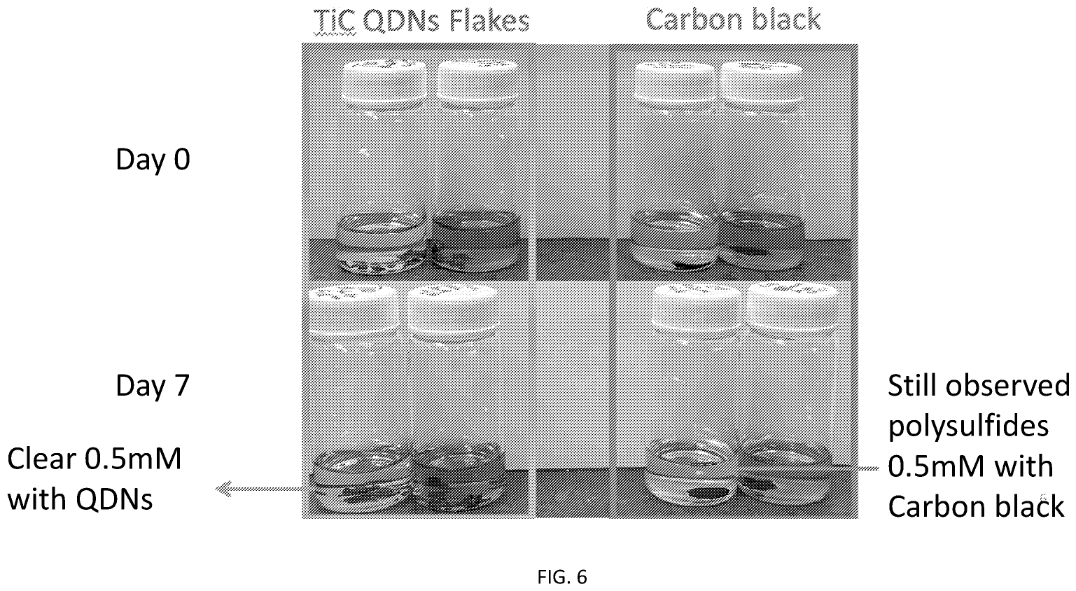

FIG. 6 provides a visual polysulfide test to observe interactions with TiC 1 Das. Compared to carbon black, the 1 Das remove more polysulfides as seen in the picture after 7 days. Two concentration were made 0.5 mM and 2 mM.

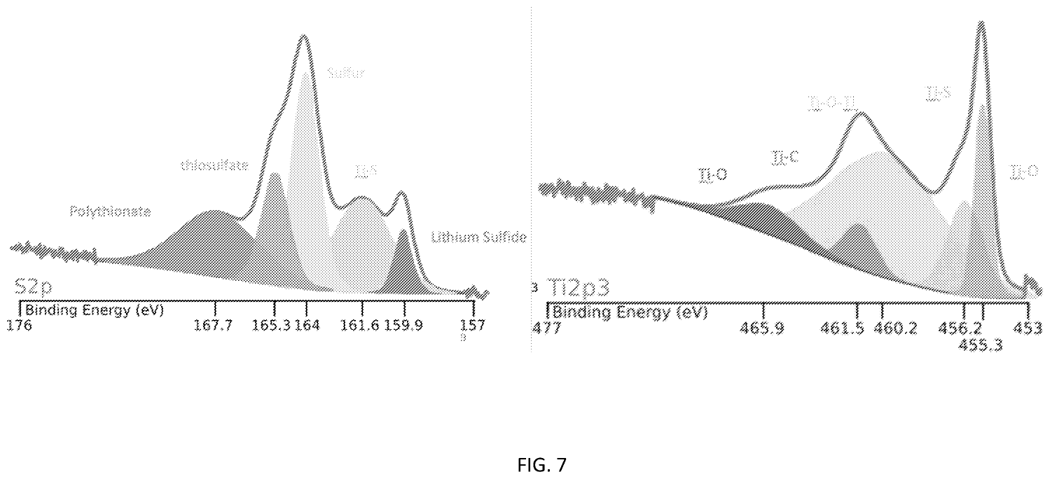

FIG. 7 provides postmortem XPS of cycled cathodes with TiC 1 Das and sulfur. The emergence of the polythionate peak in the S2p spectrum elucidates the electrocatalytic mechanism of the polysulfide absorbance of TiC 1 Das. Additionally, the occurrence of the lithium sulfur peak in both the S2p and the Ti2p spectrum demonstrates the Lewis acid base bonding mechanism.

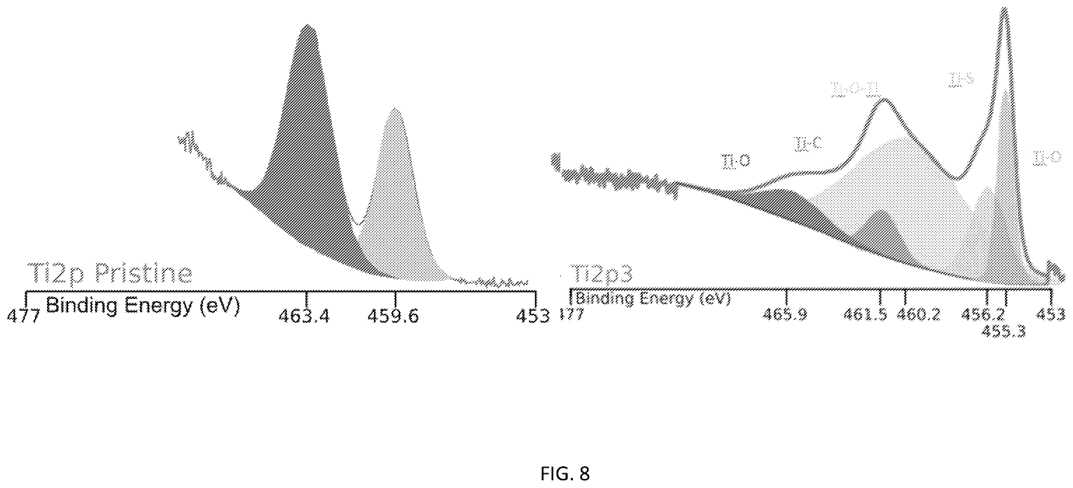

FIG. 8 compares the pristine TiC 1 Das and the postmortem TiC 1 Das, showing shifts in the Ti—O peaks (dark blue and peach). Without being bound to any particular theory, this further suggests the interaction between polysulfides and the titanium in TiC 1 Das, as changes in the Titanium coordination number can produce this shifts in binding energies.

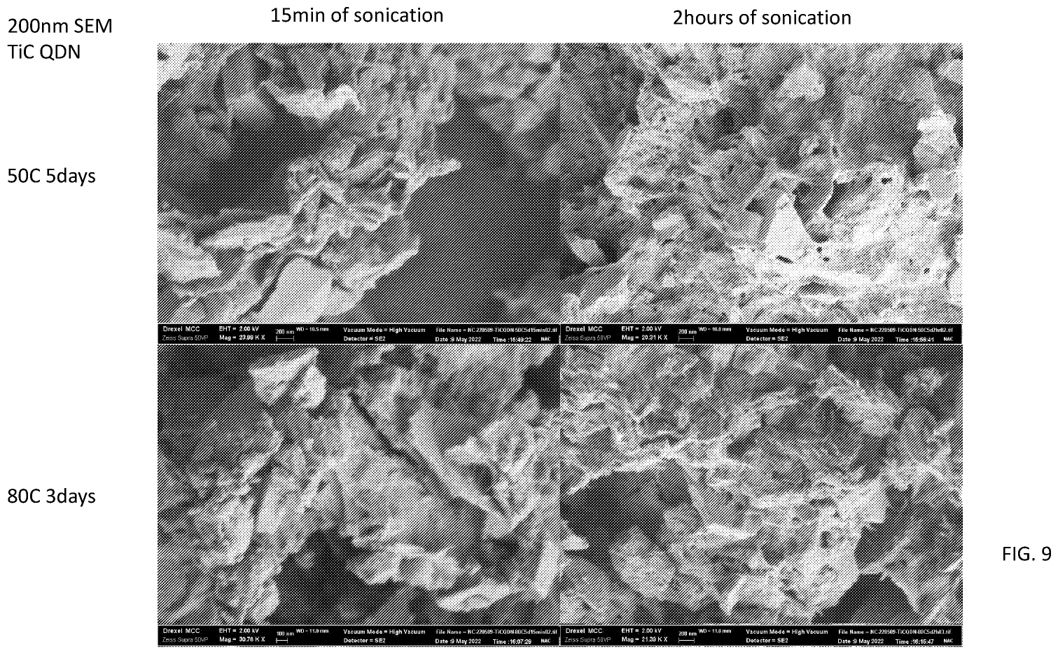

FIG. 9 provides illustrative SEM of TiC 1 Das at various sonication treatments and reaction temperatures. The sample made at 80 deg. C. for 3 days with 2 hours of sonication shows a more fibrous-like surface compared to the sample made at 50 deg. C. for 5 days with 2 h sonication.

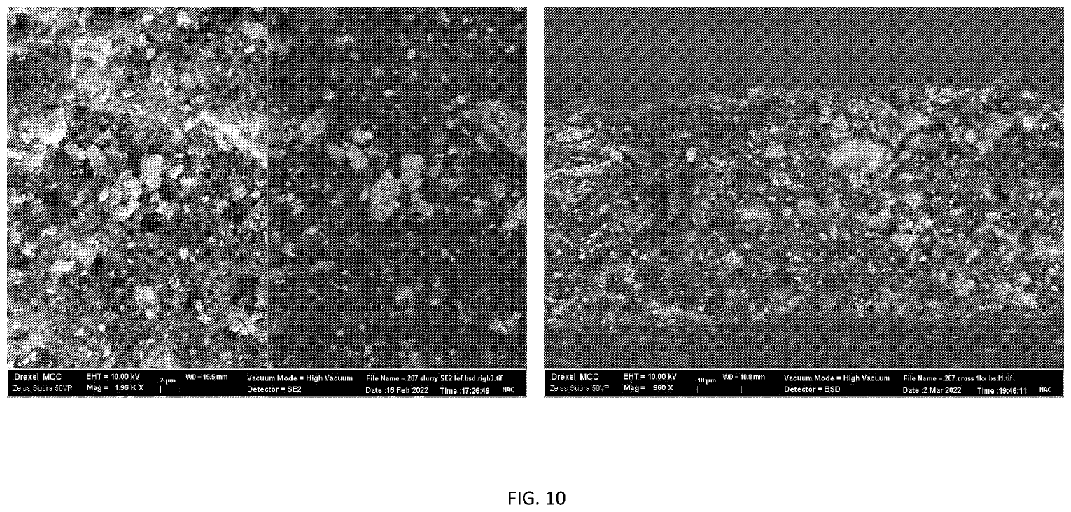

FIG. 10 provides an illustrative SEM of a cathode according to the present disclosure.

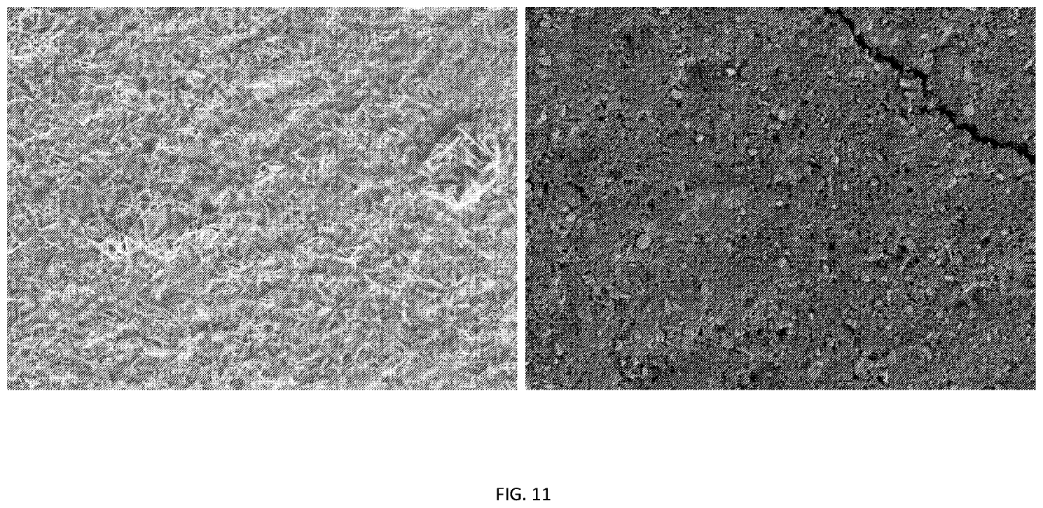

FIG. 11 provides SEM of a post-mortem 1 Das (TiC) cathode top (left) and bottom (right). As seen, the cathode maintains its morphology even after use.

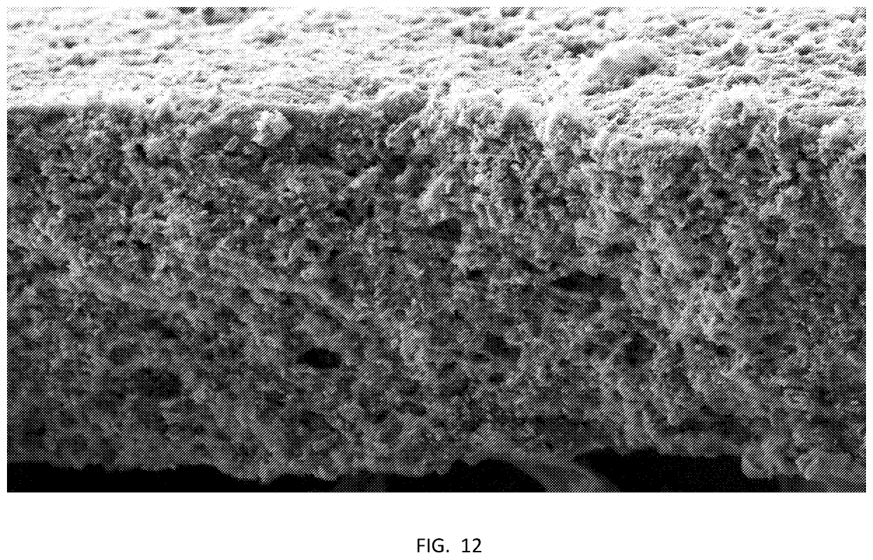

FIG. 12 provides a SEM of a post mortem 1 Das (TiC) cathode (in cross-section). As seen, the cathode maintains its morphology even after use.

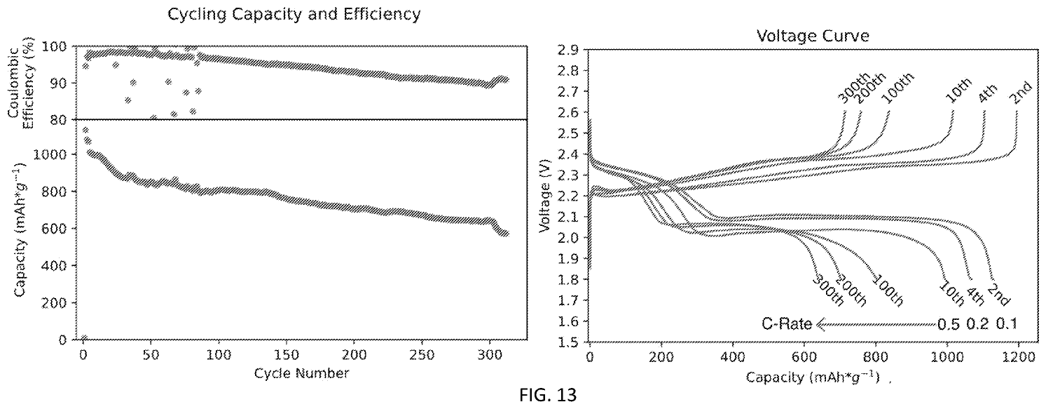

FIG. 13 provides illustrative performance for TiB 1 Das materials made at 80 deg. C. for 3 days Li—S cells, loaded with 1 mg sulfur.

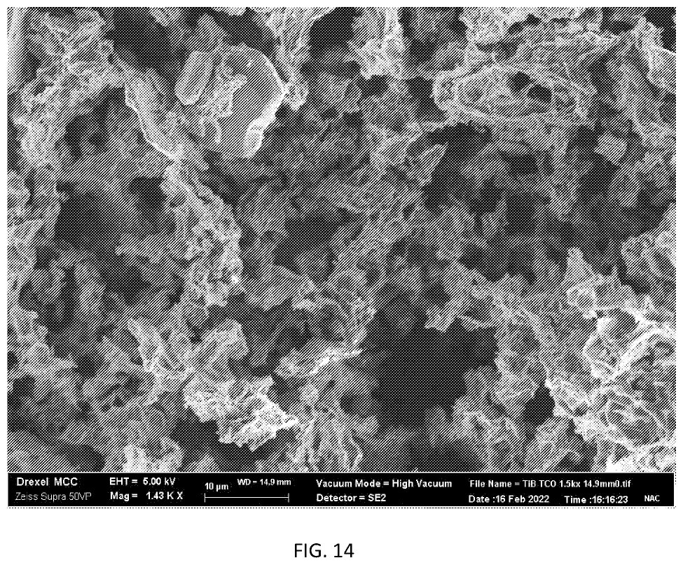

FIG. 14 provides SEM of a 1 Das TiB, made at 80 deg. C. for 3 days.

### Fabrication

The following disclosure is illustrative only and does not limit the scope of the present disclosure or the appended claims.

### Illustrative TiC 1 Das

Briefly, commercial titanium carbide (Alfa Aesar 200 mesh) or titanium boride is combined with Tetramethylammonium hydroxide (TMAOH) from Alfa Aesar in a ratio of 1 g to 10 ml of TMAOH. This is reacted at 50° C. for 5 days or 80° C. for 3 days with vigorous stirring. The product is then washed with absolute ethanol five times. The 1 Das are extracted by mixing the resulting pellet with DI water to form a colloidal. Unreacted titanium carbide is removed at this stage via the centrifuge. The colloidal of 1 Das is then added to be stirred with 5M lithium chloride (Alfa Aesar) for 24 hours. The resultant mixture is then washed with DI water and centrifuged till a neutral pH. The colloidal is then sonicated with argon (Airgas) bubbling with the temperature held below 15° C. for 2 hours. After which the colloidal is then vacuum filtered and freeze dried to form the resultant film of 1 Das.

### Preparations of Electrodes for Li—S Cells

The composite electrodes were made by the typical slurry method. For example, for a 100 mg slurry, 35 mg of the freeze-dried TiC 1 Das is combined with 35 mg with sulfur (Alfa Aesar) to form the sulfur composite. Then 20 mg of conductive carbon SuperP (Alfa Aesar) along with 10 mg of battery-grade polyvinylidene fluoride (PVDF) binder (MTI). The powders were combined dropwise with N-methyl-2-pyrrolidone (NMP) (TCI) typically about 400 microliters, zirconia mixing balls in a polypropylene Flacktek cup. The slurry was then mixed for 8 minutes in total at 2000 rpm in a Flacktek planetary mixer at which point the slurry reached the desired consistency. The resultant slurry was blade casted on aluminum foil. After being cast, the slurry was moved to a vacuum oven to be dried at 50° C. for 12 hours and retrieved once it had cooled back to room temperature. After which the electrode was freeze dried again to remove any additional water and held under vacuum for 24 hours.

### Coin Cell Fabrication

Dried cast electrodes were punched into 11 mm diameter cathodes for coin cells. These were then weighed and transferred to the ante chamber of an argon (Airgas) filled glovebox (Mbraun, Labstar, O₂<1 ppm and H₂O<1 pmm). The electrodes were assembled into CR2032 (MTI and Xiamen TMAX Battery Equipment, China) coin-type cells. The assembly also included 13 mm diameter disks of 750 μm thick lithium metal foil (Alfa Aesar) and a 19 mm Celgard 2325 separator. The lithium metal foil was placed on a stainless-steel spacer and pressure was provided by one stainless-steel spring. The electrolyte used in the cell was 1M lithium bis(trifluoromethanesulfonyl)imide (LiTFSi) with 1 wt % lithium nitrate (LiNO₃) in a mixture of 1,2-dimethoxyethane and 1,3-dioxolane at a 1:1 volume ratio was obtained from Gotion, USA with a water content of 1 ppm. The amount of electrolyte was fixed with the electrolyte to sulfur ratio of 20 μL·mg⁻¹. The coin cells were then crimped and rested for 10 hours at open-circuit potential, on average was 2.3 V. Galvanostatic tests were conducted on a multichannel MACCOR cycler (4000 series) and Neware BTS 4000 battery cycler. Cyclic stability tests were performed at room temperature in the voltage range of 1.8V to 2.6V vs. Li/Li⁺ after two cycles at 0.1 C and two cycles at 0.2 C as conditioning cycles (1 C=1672 mAh·g⁻¹). Cyclic voltammetry was performed using a potentiostat (VMP3, Biologic, France) in voltage range of 1.8V to 2.6V vs. Li/Li at scan rates ranging from 0.1 mV·s⁻¹ to 0.5 mV·s⁻¹.

### Material Characterization

X-ray diffraction was used to characterize the 1 Das on a diffractometer (Miniflex, Rigaku, Japan) using a Cu-Kα radiation (40 kV and 15 mA), in the 5° to 60° 2θ range. X-ray photoelectron spectroscopy was performed on a Physical Electronics VersaProbe 5000 with an Al-Kα source with a 1486.2 eV and an argon gun was used for the post-mortem cycled cathodes to remove electrolyte surface species. Scanning electron microscopy was used to characterize the morphology of the samples, performed on a Zeiss Supra VP50 field emission scanning electron microscope with a Everhart-Thornley secondary electron detector and Oxford UltiMax 40 mm energy dispersive spectrometer with a silicon drift detector for elemental analysis. Sulfur weight percent was confirmed in from the composite slurry using a thermogravimetric analyzer from Setaram Setline STA in ultra-high purity nitrogen (Airgas) at a 5° C. min⁻¹

### Further Fabrication Techniques

One example synthesis process entails immersing precursor powders in 25 wt. % TMAH in polyethylene jars that are heated on a hot plate at temperatures that ranged from room temperature (RT) to 85° C. and for durations from 24 h to a week. (Durations longer than 1 week can also be used, e.g., 1, 2, 3, 4, 5, 6, 7, 8, 9, 10, 11, 12, 13, 14, or even 15 days and all intermediate ranges and values.) After reaction with the TMAH, (except for Ti₂SbP, TiB₂ and TiO₂) a dark black sediment was obtained, collected, and rinsed with ethanol, shook, and centrifuged at 3500 rpm for multiple cycles until a clear supernatant was obtained. Once the supernatant was clear, 30 mL of deionized, DI, water was added to the washed products and shook for 5 mins. After centrifugation at 3500 rpm for 0.5 h, without sonication, a stable colloidal suspension was obtained. Any unreacted powders settled down. The colloid was then vacuum filtered to produce FF some of which were characterized.

In some cases, an additional step of washing with LiCl solution was conducted and the produced flakes were characterized. A 5M LiCl solution was added to the black colloidal suspension obtained above. This resulted in deflocculation. The sediment was shaken and rinsed with deionized water through centrifugation at 5000 rpm for three cycles. The LiCl/DI water washing process was repeated until the pH was ˜7. The washed sediment was then sonicated in a cold bath for 1 h under flowing Ar, shaken for 5 min, then centrifuged at 3500 rpm for 10 min. The colloidal suspension was filtered to produce FFs. The FFs were then left to dry in a vacuum chamber overnight before further characterization.

In few cases, the black slurry—produced from the reaction of TMAH and TiC—centrifuged (at 5000 rpm for 5 min) directly without the addition of any solvents, the supernatant decanted, the sediment resuspended in 20 mL DI water, shook for 5 min, then centrifuged at 3500 rpm for 30 min. The produced black colloidal suspension was used for XRD (not shown) and TEM inspection.

Without being bound to any particular theory, one can fabricate the disclosed materials by contacting a mono-, binary, ternary, or higher carbide, nitride, boride, phosphide, aluminide, or silicide, or titanium metal with a quaternary ammonium salt and/or base, the mono-, binary, ternary, or higher carbide, nitride, boride, phosphide, aluminide, or silicide, or titanium metal optionally being non-water-soluble, the non-water soluble binary, or ternary, or higher carbide, nitride, boride, phosphide, aluminide, or silicide optionally comprising a transition metal, the transition metal optionally comprising titanium, the contacting being performed under conditions sufficient to give rise to a nanofilamentous (and/or subnanofilamentous) product, i.e., 1 Da. The product can self-assemble into 2D flakes.

Example carbides include, e.g., titanium carbide, zirconium carbide, hafnium carbide, vanadium carbide, niobium carbide, tantalum carbide, chromium carbide, molybdenum carbide, tungsten carbide, iron carbide, and the like. Example nitrides include, e.g., aluminum nitride, boron nitride, calcium nitride, cerium nitride, europium nitride, gallium nitride, indium nitride, lanthanum nitride, lithium nitride, magnesium nitride, niobium nitride, silicon nitride, strontium nitride, tantalum nitride, titanium nitride, vanadium nitride, zinc nitride, zirconium nitride, and the like.

Example borides include, e.g., aluminium diboride, aluminium dodecaboride, aluminium magnesium boride, barium boride, calcium hexaboride, cerium hexaboride, chromium(III) boride, cobalt boride, dinickel boride, erbium hexaboride, erbium tetraboride, hafnium diboride, iron boride, iron tetraboride, lanthanum hexaboride, magnesium diboride, nickel boride, niobium diboride, osmium boride, plutonium borides, rhenium diboride, ruthenium boride, samarium hexaboride, scandium dodecaboride, silicon boride, strontium hexaboride, tantalum boride, titanium diboride, trinickel boride, tungsten boride, uranium diboride, yttrium boride, zirconium diboride, and the like.

Example phosphides include, e.g., aluminium gallium indium phosphide, aluminium gallium phosphide, aluminium phosphide, bismuth phosphide, boron phosphide, cadmium phosphide, calcium monophosphide, calcium phosphide, carbon monophosphide, cobalt(II) phosphide, copper(I) phosphide, dysprosium phosphide, erbium phosphide, europium(III) phosphide, ferrophosphorus, gadolinium phosphide, gallium arsenide phosphide, gallium indium arsenide antimonide phosphide, gallium phosphide, holmium phosphide, indium arsenide antimonide phosphide, indium gallium arsenide phosphide, indium gallium phosphide, indium phosphide, iron phosphide, lanthanum phosphide, lithium phosphide, lutetium phosphide, neodymium phosphide, niobium phosphide, phosphide carbide, phosphide chloride, phosphide silicide, -plutonium phosphide, praseodymium phosphide, samarium phosphide, scandium phosphide, sodium phosphide, strontium phosphide, telluride phosphide, terbium phosphide, thulium phosphide, titanium(III) phosphide, uranium monophosphide, ytterbium phosphide, yttrium phosphide, zinc diphosphide, zinc cadmium phosphide arsenide, and zinc phosphide.

Example aluminides include, e.g., magnesium aluminide, titanium aluminide, iron aluminide, and nickel aluminide.

Example silicides include, e.g., nickel silicide, sodium silicide, magnesium silicide, platinum silicide, titanium silicide, tungsten silicide, and molybdenum silicide.

Without being bound to any particular theory or embodiment, mono-, binary, or ternary, or higher carbides, nitrides, borides, phosphides, aluminides, or silicides that comprise titanium are particularly suitable. Similarly, titanium sponge is considered a particularly suitable form of titanium metal for use with the disclosed technology. For example, one can contact titanium sponge with a quaternary ammonium salt as described herein so as to give rise to a nanofilamentous (or subnanofilamentous) product, as described herein.

The fabrication conditions can comprise a temperature of from 0 to 100° C., to 200° C., or even to 300° C. for from about 0.5 hours to about 1, 2, 3, 4, or 5 weeks. The temperature can be constant during the time of exposure, but can also be varied, e.g., increased and/or decreased. The temperature can be, e.g., from about 0 to about 300° C., from about 5 to about 95° C., from about 10 to about 90° C., from about 15 to about 85° C., from about 20 to about 80° C., from about 25 to about 75° C., from about 30 to about 70° C., from about 35 to about 65° C., from about 40 to about 60° C., from about 45 to about 55° C., or even about 50° C. Temperatures from 100 to 200° C. are also suitable. The temperature can be varied during the exposure (e.g., exposure to a first temperature and then a second temperature), but this is not a requirement. The exposure can be, e.g., according to a preprogrammed schedule that sets temperatures and/or durations of exposure. The exposure temperature can be, e.g., about 25, about 30, about 35, about 40, about 45, about 50, about 55, about 60, about 65, about 70, about 75, about 80, about 90, about 95, or even about 100° C.

The conditions can, in some embodiments, comprise a temperature of from about 20 to about 300° C. and an exposure of from about 0.5 hours to about 2, 3, 4, or even 5 weeks. The conditions can comprise a temperature of about 100 to about 200° C. and an exposure of from about 1 hours to about 1 week. The temperature can be constant during the time of exposure, but can also be varied, e.g., increased and/or decreased. The temperature can be, e.g., from about 100 to about 200° C., from about 105 to about 195° C., from about 100 to about 190° C., from about 115 to about 185° C., from about 120 to about 180° C., from about 25 to about 175° C., from about 130 to about 170° C., from about 135 to about 165° C., from about 140 to about 160° C., from about 145 to about 155° C., or even about 150° C. The temperature can be varied during the exposure (e.g., exposure to a first temperature and then a second temperature), but this is not a requirement.

The exposure can be, e.g., according to a preprogrammed schedule that sets temperatures and/or durations of exposure. The exposure temperature can be, e.g., about 125, about 130, about 135, about 140, about 145, about 150, about 155, about 160, about 165, about 170, about 175, about 180, about 190, about 195. The method can be performed in a closed system, e.g., in a pressure vessel. The pressure can be atmospheric, but can also be less than atmospheric pressure or even can be greater than atmospheric pressure, e.g., a pressure of greater than 1 atmosphere (101.325 kPa) to about 10 atmospheres (1013.250 kPa).

The period of exposure (which can be termed a “reaction time”) can be, e.g., from about 1 hours to about 7 days, from about 5 hours to about 6 days, from about 15 hours to about 5 days, from about 20 hours to about 4 days, from about 24 hours to about 3 days, or even about 2 days. As but some example, the exposure can be for from 12 hours to about 72 hours, about 15 hours to about 70 hours, about 18 hours to about 64 hours, about 24 hours to about 60 hours, about 30 hours to about 55 hours, about 33 hours to about 52 hours, about 37 hours to about 48 hours, about 40 hours to about 45 hours, and all intermediate values and sub-combinations of ranges.

The fabrication can comprise, e.g., contacting a mono-, binary, ternary, or higher boride (which can comprise Ti) with a quaternary ammonium salt and/or base so as to give rise to a product, which product can be nanofilamentous and/or subnanofilamentous. The binary boride can comprise one or more titanium borides. The quaternary ammonium salt and/or base can comprise an ammonium hydroxide, an ammonium halide, or any combination thereof.

The quaternary ammonium hydroxide can comprise, e.g., tetramethylammonium hydroxide (TMAOH), tetraethylammonium hydroxide (TEAOH), tetrapropylammonium hydroxide (TPAOH), tetrabutylammonium hydroxide (TBAOH), ammonium hydroxide (NH₄OH), their amine derivatives, or any combination thereof. The quaternary ammonium salt can comprise a quaternary ammonium chloride, a quaternary ammonium bromide, a quaternary ammonium iodide, a quaternary ammonium fluoride, or any combination thereof. It should be understood that one can use either or both of a quaternary ammonium salt and a quaternary ammonium base.

Fabrication can further comprise filtering the product. Fabrication can also comprise washing the product with a metal salt and/or other water-soluble metal compound.

The metal salt can be a metal halide salt, e.g., a Li halide, a Na halide, a K halide, an Rb halide, a Cs halide, a Fr halide, a Be halide, a Mg halide, a Ca halide, a Sr halide, a Ba halide, a Ra halide, a Mn halide, a Fe halide, a Ni halide, a Co halide, a Cu halide, a Zn halide, a Mo halide, a Nb halide, a W halide, or any combination thereof.

The product can also be washed with a metal salt and/or water-soluble metal compounds. The metal salt can optionally comprise metal sulfate, nitrate, chromate, acetate, carbonate, permanganate, or metal hydroxide, or any combination of thereof. The metal in the salt can be essentially any metal from the periodic table.

As but some non-limiting examples, the metal in the metal salt can be Li, Na, K, Cs, Mg, Ca, Cr, Mn, Fe, Co, Ni, Cu, Zn, Nb, Mo, Cd, Ta, or W, or any combination of thereof. A metal salt can be, e.g., LiCl, KCl, NaCl, LiF, KF, NaF, LiGH, KOH, NaOH, or any combination thereof. The metal salt can also be, e.g., LiCl, KCl, NaCl, LiF, CsCl, KF, NaF, LiGH, KOH, NaOH, or any combination thereof. The metal salt can also be, e.g., CrCl₃, MnCl₂, FeCl₂, FeCl₃, CoCl₂, NiCl₂, MoCl₅, FeSO₄, (NH₄)₂Fe(SO₄)₂, CuCl₂, CuCl, ZnCl₂ or any combination thereof.

The product can be, e.g., a nanofilamentous (and/or subnanofilamentous) product that exhibits a XRD pattern that, when compared to a XRD pattern of nano- or bulk anatase, exhibit reduced (104) and (105) peaks at around 380 and about 550 two theta (2θ). As described elsewhere herein, the disclosed nanofilaments and/or subnanofilaments can, in some embodiments, exhibit a Raman spectrum that is similar to that of bulk anatase, but can differ from bulk anatase in terms of the XRD spectrum, as described herein.

### Aspects

The following Aspects are illustrative only and do not limit the present disclosure or the appended claims.

Aspect 1. A composition, comprising a chalcogen, an 1 Das, and optionally a conductive material. The composition can also include a binder; suitable binders are described elsewhere herein.

Aspect 2. The composition of Aspect 1, wherein the chalcogen comprises sulfur.

Aspect 3. The composition of Aspect 2, wherein the composition comprises sulfur (or other chalcogen) present at a loading at from about 0.05 to about 150 mg chalcogen per cm², e.g., from about 1 to about 20 mg/cm².

Aspect 4. The composition of any one of Aspects 1-3, wherein the 1 Da comprises titanium oxide and/or titanium carbo-oxide.

Aspect 5. An electrode, the electrode comprising a composition according to any one of Aspects 1-4, and the electrode optionally being configured as a cathode.

Aspect 6. The electrode of Aspect 5, the electrode comprising a ceramic matrix composite (CMC), polyvinylidene fluoride (PVDF), polyacrylic acid (PAA), polyvinyl alcohol (PVA), polyethylene glycol (PEG), sodium carboxymethyl chitosan (CCTS), sodium alginate (SA), styrene-butadiene rubber (SBR), or any combination thereof.

An electrode can also include a conductive material, e.g., a carbonaceous material. The conductive material can be, e.g., a MXene, a metal or metalloid particle, and the like. Metallic particles are considered particularly suitable, as are MXenes, graphene, carbon nanotubes (single-wall and/or multi-wall), and the like.

The conductive material can include one component (e.g., a single type of carbon nanotubes), but can also include multiple components (e.g., carbon nanotubes and also MXenes).

Aspect 7. The electrode of Aspect 5, wherein (a) the electrode exhibits a capacity of about 300-1675 mAh g⁻¹, (b) wherein the electrode exhibits substantially the same capacity over at least about 10 cycles, or both (a) and (b).

An electrode can comprise a chalcogen (e.g., sulfur) that is present at from about 30 to about 99 wt % of the electrode, e.g., from about 30 to about 99 wt %, from about 35 to about 95 wt %, from about 40 to about 90 wt %, from about 45 to about 85 wt %, from about 50 to about 80 wt %, from about 55 to about 75 wt %, from about 60 to about 70 wt %, or even about 65 wt %.

The loading of a chalcogen (e.g., sulfur) can also be defined in terms of weight per area, i.e., described in terms of mg (chalcogen) per cm² (electrode). In some embodiments, the chalcogen is present at from about 0.05 to about 150 mg/cm², from about 1 to about 20 mg/cm², or from about 2 to about 19 mg/cm², or from about 3 to about 18 mg/cm², or from about 4 to about 17 mg/cm², or from about 5 to about 16 mg/cm², or from about 6 to about 15 mg/cm², or from about 7 to about 14 mg/cm², or from about 8 to about 13 mg/cm², or from about 9 to about 12 mg/cm², or even from about 10 to about 11 mg/cm².

Aspect 8. An energy cell, the energy cell comprising a first electrode according to any one of Aspects 5-7.

Aspect 9. The energy cell of Aspect 8, wherein the energy cell comprises a second electrode, the second electrode comprising an alkali metal, an alkaline metal, a transition metal, graphite, an alloy, silicon, graphene, or any combination thereof.

Aspect 10. The energy cell of Aspect 9, wherein the second electrode comprises at least one of lithium, sodium, potassium, magnesium, calcium, zinc, copper, titanium, nickel, cobalt, iron, and aluminum.

Aspect 11. The energy cell of any one of Aspects 9-10, wherein the first electrode is characterized as a cathode and wherein the second electrode is characterized as an anode.

Aspect 12. The energy cell of any one of Aspects 8-11, further comprising an electrolyte, the electrolyte optionally comprising ether and/or carbonate. Other electrolytes, e.g., an electrolyte that comprises alkali metal ions and/or halide ions, can be used.

Aspect 13. The energy cell of Aspect 12, further comprising a separator, the separator optionally comprising one or more of polypropylene, polyethylene, glass fiber, or porous rubber.

Aspect 14. A method, the method comprising discharging an energy cell according to any one of Aspects 8-13 or charging an energy cell according to any one of Aspects 8-13.

Aspect 15. An electrical device, comprising an energy cell according to any one of Aspects 8-13.

Aspect 16. A method, comprising: forming an admixture that comprises a chalcogen, a 1 Da, and optionally a conductive material. Example chalcogens include, e.g., oxygen, sulfur, selenium, tellurium, and polonium; sulfur is considered particularly suitable.

The admixture can also include a binder, e.g., a polymer. Example polymers include, e.g., PVDF (polyvinylidene fluoride) and SBR (Styrene Butadiene Rubber). A binder can include one component (e.g., SBR), but can also include multiple components (e.g., SBR and PVDF).

Aspect 17. The method of Aspect 17, wherein the conductive material comprises a carbonaceous material; the conductive material can be, e.g., a MXene, a metal or metalloid particle, and the like. Metallic particles are considered particularly suitable, as are MXenes, graphene, carbon nanotubes (single-wall and/or multi-wall), and the like. The conductive material can include one component (e.g., a single type of carbon nanotubes), but can also include multiple components (e.g., carbon nanotubes and also MXenes).

Aspect 18. The method of any one of Aspects 16-17, wherein the 1 Da comprises titanium oxide and/or titanium carbo-oxide.

Aspect 19. The method of any one of Aspects 16-18, wherein the chalcogen comprises sulfur. The chalcogen (e.g., sulfur) can be present at from about 30 wt % to 99 wt % in the admixture, including all intermediate values and sub-ranges. For example, the chalcogen can be present at 30 wt %, 35 wt %, 40 wt %, 50 wt %, 55 wt %, 50 wt %, 55 wt %, 60 wt %, 65 wt %, 70 wt %, 75 wt %, 80 wt %, 85 wt %, 90 wt %, 95 wt %, or even 99 wt % and all intermediate values and sub-ranges. As some examples, the chalcogen can be present at from about 30 to about 99 wt %, about 35 to about 95 wt %, about 40 to about 90 wt %, about 45 to about 85 wt %, about 50 to about 80 wt %, about 55 to about 75 wt %, about 60 to about 70 wt %, or even about 65 wt %.

Aspect 20. The method of any one of Aspects 16-19, further comprising forming an electrode from the admixture. An electrode can be used as, e.g., a cathode. Such an electrode can be an electrode according to the present disclosure, e.g., according to any one of Aspects 5-7.

What is claimed:

1. A composition, comprising a chalcogen, an 1 Da, and optionally a conductive material.

2. The composition of claim 1, wherein the chalcogen comprises sulfur.

3. The composition of claim 2, wherein the composition comprises a chalcogen present at a loading at from about 0.05 to about 150 mg chalcogen per cm², optionally from about 1 to about 20 mg chalcogen per cm², the chalcogen optionally comprising sulfur.

4. The composition of claim 1, wherein the 1 Da comprises titanium oxide and/or titanium carbo-oxide.

5. An electrode, the electrode comprising a composition according to claim 1, and the electrode optionally being configured as a cathode.

6. The electrode of claim 5, the electrode comprising a ceramic matrix composite (CMC), styrene-butadiene rubber (SBR), polyvinylidene fluoride (PVDF), polyacrylic acid (PAA), polyvinyl alcohol (PVA), polyethylene glycol (PEG), sodium carboxymethyl chitosan (CCTS), sodium alginate (SA), or any combination thereof.

7. The electrode of claim 5, wherein (a) the electrode exhibits a capacity of about 300-1675 mAh g⁻¹, (b) wherein the electrode exhibits substantially the same capacity over at least about 10 cycles, or both (a) and (b).

8. An energy cell, the energy cell comprising a first electrode according to claim 5.

9. The energy cell of claim 8, wherein the energy cell comprises a second electrode, the second electrode comprising an alkali metal, an alkaline metal, a transition metal, graphite, an alloy, silicon, graphene, or any combination thereof.

10. The energy cell of claim 9, wherein the second electrode comprises at least one of lithium, sodium, potassium, magnesium, calcium, zinc, copper, titanium, nickel, cobalt, iron, and aluminum.

11. The energy cell of claim 9, wherein the first electrode is characterized as a cathode and wherein the second electrode is characterized as an anode.

12. The energy cell of claim 8, further comprising an electrolyte, the electrolyte optionally comprising ether and/or carbonate.

13. The energy cell of claim 12, further comprising a separator, the separator optionally comprising one or more of polypropylene, polyethylene, glass fiber, or porous rubber.

14. A method, the method comprising discharging an energy cell according to claim 8 or charging an energy cell according to claim 8.

15. An electrical device, comprising an energy cell according to claim 8.

16. A method, comprising:
forming an admixture that comprises a chalcogen, a 1 Da, and optionally a conductive material.

17. The method of claim 17, wherein the conductive material comprises a carbonaceous material.

18. The method of claim 16, wherein the 1 Da comprises titanium oxide and/or titanium carbo-oxide.

19. The method of claim 16, wherein the chalcogen comprises sulfur.

20. The method of claim 16, further comprising forming an electrode from the admixture.
